(19) United States
(12) Patent Application Publication
(10) Pub. No.: US 2009/0203358 A1
(43) Pub. Date: Aug. 13, 2009

(54) MOBILE APPARATUS

(75) Inventors: Hironori YOSHIDA, Sagamihara-shi (JP); Kazuhito HADA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/206,173

(22) Filed: Sep. 8, 2008

(30) Foreign Application Priority Data
Feb. 12, 2008 (JP) P2008-030960

(51) Int. Cl. H04M 1/725

(52) U.S. Cl. 455/412.2

(57) ABSTRACT

According to one aspect of the invention, a mobile apparatus includes: a notification section configured to notify a user of an incoming mail by means of sound or vibration; a display section configured to display mail information related to the incoming mail; a setting section configured to set an operation time of the notification section and to store the operation time based on the user's operation; and a control section configured to activate the notification section during the operation time and to control the display section to scroll the mail information if the incoming mail is received. If the operation time elapses, the control section controls the display section to continue a scrolling unless an end part of the mail information is displayed.

The entire disclosure of Japanese Patent Application No. 2008-030960 filed on Feb. 12, 2008 including specification, claims, drawings and abstract is incorporated herein by reference in its entirety.

### BACKGROUND

1. Field of the Invention

One embodiment of the present invention relates to a mobile apparatus for carrying out an incoming call ring and displaying an incoming mail and phone call information when the incoming mail or the incoming phone call is received.

2. Description of the Related Art

In a mobile apparatus such as a portable telephone, an incoming ring and a display of an incoming mail and phone call information are carried out when the incoming mail or the incoming phone call is received. Referring to a time required for a mail incoming ring, a user can set an optional ring time. The mail information to be displayed includes at least one of a mail address of a sender, the sender name, a mail subject and a mail text.

When a mail is received, it is displayed in a sub display portion which can be seen in a folded condition and has a display area limited comparatively in such a manner that a user can see the mail without an operation for opening a foldable mobile apparatus on purpose. In the case in which the sender name in an address book is long, it cannot be completely displayed in the sub display portion at a time. Therefore, the sender name is displayed with scrolling. When the mobile apparatus is opened, moreover, a main display portion and a main portion are woken up so that a consumed power is increased. Therefore, it is desirable that the sender name can be checked through the sub display portion without opening the mobile apparatus.

When a mail is received, a control portion of the mobile apparatus starts the mail incoming ring and displays, in the sub display portion, the sender name in the address book corresponding to an address of the sender of header information about the incoming mail. When the incoming ring time elapses, then, the incoming ring is stopped and the display of the sender name is also cancelled in conjunction therewith. In the case in which the incoming ring time of the mail is short and the sender name in the address book is long, accordingly, the display is ended before all of the sender name is displayed also when the scrolling display of the sub display portion is being carried out.

There have been proposed a portable telephone and a remote controller which serve to carry out a scrolling display when a mail is received (see JP-A-2004-134840 (Paragraph [0030], FIG. 5), for instance). In the portable telephone and the remote controller in JP-A-2004-134840, an sender name is scrolling displayed in a liquid crystal display portion of a limited area in the remote controller when the mail is received. The mail incoming ring has not been described.

In a conventional mobile apparatus, in the case in which the user sets a short incoming ring time for a mail and the sender name in the address book is set to be long by a user, there is a problem in that a display is ended without a user checking an entire scrolling display of a long sender name when the user becomes aware of the mail incoming ring and tries to check the sender name.

Referring to the portable telephone disclosed in JP-A-2004-134840, furthermore, there have not been described a time required for the scrolling display of the sender name and the mail incoming ring when the mail is received.

### SUMMARY

According to one aspect of the invention, a mobile apparatus includes: a notification section configured to notify a user of an incoming mail by means of sound or vibration; a display section configured to display mail information related to the incoming mail; a setting section configured to set an operation time of the notification section and to store the operation time based on the user's operation; and a control section configured to activate the notification section during the operation time and to control the display section to scroll the mail information if the incoming mail is received, wherein, if the operation time elapses, the control section controls the display section to continue a scrolling unless an end part of the mail information is displayed.

### BRIEF DESCRIPTION OF THE DRAWINGS

Embodiment may be described in detail with reference to the accompanying drawings, in which:

FIG. 1A is an exemplary view showing an appearance of a mobile apparatus according to embodiments of the invention;

FIG. 1B is an exemplary explanatory view showing a sub display portion according to the embodiments;

FIG. 2 is an exemplary block diagram showing the mobile apparatus according to the embodiments;

FIGS. 3A to 3C are exemplary diagrams for showing various flags to be exchanged between an incoming call receiving portion 15 and an incoming call notifying control portion 16 in the mobile apparatus according to the embodiments;

FIG. 4 is an exemplary operation flowchart for the incoming call receiving portion 15 of the mobile apparatus according to the embodiments;

FIG. 5 is an exemplary operation flowchart for an incoming call notifying control portion 16 of a mobile apparatus 100 according to an first embodiment; and

FIG. 6 is an exemplary operation flowchart for an incoming call notifying control portion 16 of a mobile apparatus 100 according to a second embodiment.

### DETAILED DESCRIPTION OF THE EMBODIMENTS

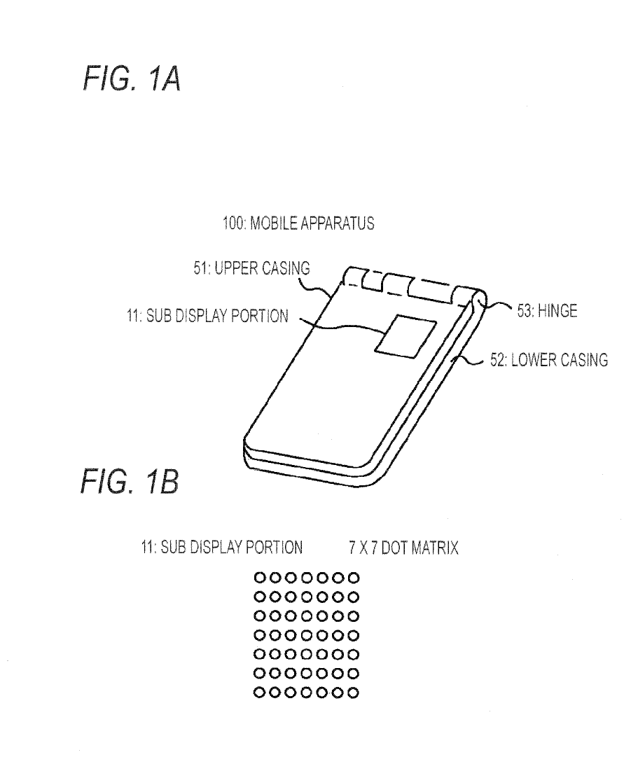

FIGS. 1A and 1B are an exemplary view showing an appearance of a mobile apparatus and an exemplary view for explaining a sub display portion according to each embodiments of the invention.

FIG. 1A is a view showing an appearance in a state in which a foldable mobile apparatus 100 is closed, and an upper casing 51 and a lower casing 52 are openably connected to each other through a hinge 53 and a sub display portion 11 is disposed on the upper casing 51. The sub display portion 11 is disposed to be seen from an outside in a state in which the mobile apparatus 100 is closed. A main display portion which is not shown is disposed in a position in which the upper casing 51 faces the lower casing 52.

FIG. 1B is a detailed view showing the sub display portion 11 in which LEDs are disposed in a 7×7 dot matrix. The sub display portion 11 has a feature that it can be fabricated very thinly. Accordingly, it is possible to fabricate the mobile apparatus 100 taking a thin shape. However, since the 7 X 7 dot matrix is employed, several characters can be simultaneously displayed at most. Therefore, much mail and phone call information cannot be displayed at the same time and a scrolling display is to be carried out. In addition, a long time is required for the scrolling.

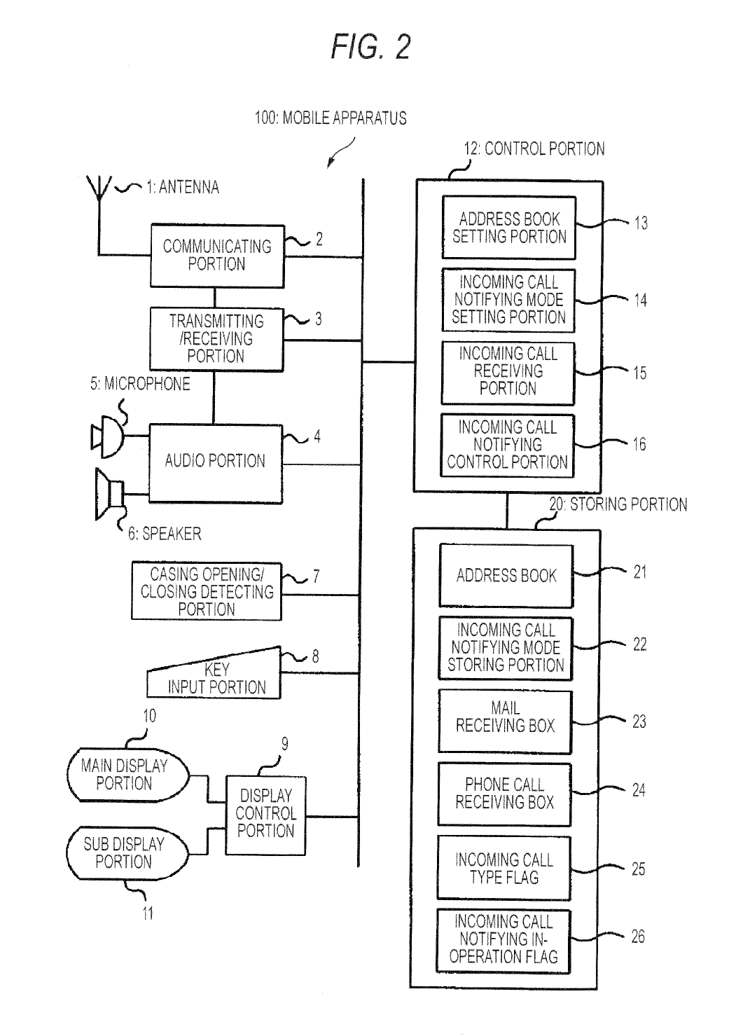

FIG. 2 is an exemplary block diagram showing the mobile apparatus. The mobile apparatus 100 is configured of an antenna 1, a communicating portion 2, a transmitting/receiving portion 3, a audio portion 4, a microphone 5, a speaker 6, a casing opening/closing detecting portion 7, a key input portion 8, a display control portion 9, a main display portion 10, a sub display portion 11, a control portion 12, and a storing portion 20. Furthermore, the control portion 12 has an address book setting portion 13, an incoming call notifying mode setting portion 14, an incoming call receiving portion 15, and an incoming call notifying control portion 16. The storing portion 20 has an address book 21, an incoming call notifying mode storing portion 22, a mail receiving box 23, a phone call receiving box 24, an incoming call type flag 25, and an incoming call notifying in-operation flag 26.

The antenna 1 transmits/receives a radio wave together to/from a base station (not shown). The communicating portion 2 transmits, to the transmitting/receiving portion 3, a high frequency signal received at the antenna 1, and transmits a high frequency signal transmitted from the transmitting/receiving portion 3 by the antenna 1.

The transmitting/receiving portion 3 amplifies, frequency-converts and demodulates the high frequency signal sent from the communicating portion 2 and transmits, to the audio portion 4, voice data thus obtained. Moreover, the transmitting/receiving portion 3 detects an incoming mail and an incoming phone call and sends, to the control portion 12, an incoming mail signal and an incoming phone call signal, received mail data, and voice data. In addition, a digital audio signal transmitted from the audio portion 4 and mail data transmitted from the control portion 12 are modulated, frequency-converted and amplified to obtain a high frequency signal, and the high frequency signal is then sent to the communicating portion 2.

The audio portion 4 converts, into an analog audio signal, the digital audio signal transmitted from the transmitting/receiving portion 3, and amplifies the analog audio signal and sends the amplified signal to the speaker 6. Moreover, the audio portion 4 amplifies an analog audio signal transmitted from the microphone 5, and converts the analog audio signal into a digital audio signal and transmits the digital audio signal to the transmitting/receiving portion 3.

The microphone 5 serves to input a voice such as a transmission. The speaker 6 serves to output a receiving sound and to output various notices such as an incoming ring sound when a mail or a phone call is received. The casing opening/closing detecting portion 7 serves to detect the opening/closing state of the casings of the foldable mobile apparatus 100 and detects the opening/closing state of the casings through a proximity detection by a magnet (not shown) provided in one of the casings and a magnetic sensor (not shown) provided in the other casing. The key input portion 8 serves as various key input means through a user's operation.

The display control portion 9 controls a display of mail data, a still picture and a moving picture in the main display portion 10 and the sub display portion 11 and a display of notifying information such as a radio wave condition of the mobile apparatus 100 based on a request given from the control portion 12.

The main display portion 10 is provided on a side where the upper and lower casings of the mobile apparatus 100 are folded to face each other, and has a large display area. In a folded state, the user cannot see the main display portion 10. The sub display portion 11 is provided on an external face in a state in which the upper and lower casings of the mobile apparatus 100 are folded, and has a comparatively small display area. Also in the folded state, the user can see the sub display portion 11.

The user usually carries the mobile apparatus 100 in the folded state. Therefore, mail information is displayed on the sub display portion 11 in such a manner that the user can see the mail information without any operation in the folded state when a mail is received. In the folded state, moreover, power saving can be realized.

The control portion 12 is configured of a CPU, an ROM and an RAM which are not shown and operates various functions based on software stored in the ROM. A processing portion based on the software includes the address book setting portion 13, the incoming call notifying mode setting portion 14, the incoming call receiving portion 15, and the incoming call notifying control portion 16.

The address book setting portion 13 previously records mail addresses and names of other parties and in the address book 21 based on a signal transmitted from the key input portion 8 based on a user's operation.

The incoming call notifying mode setting portion 14 is previously set to output ring sound or output a vibration through a vibrator which is not shown when an incoming mail and an incoming phone call are received based on the signal transmitted from the key input portion 8 based on the user's operation. The incoming call notifying mode setting portion 14 also records a duration of an output time, for example, “five seconds”, in the incoming call notifying mode storing portion 22.

The processing of the address book setting portion 13 and the incoming call notifying mode setting portion 14 have conventionally been carried out and an operation flowchart thereof will be omitted.

The incoming call receiving portion 15 is started in response to an incoming call signal sent from the transmitting/receiving portion 3 and determines whether an incoming mail or phone call is received in response to the signal sent from the transmitting/receiving portion 3. In case of the mail, it is recorded in the mail receiving box 23. In case of the phone call, a telephone number of a sender is recorded in the phone call receiving box 24 if it is known. Moreover, the incoming call receiving portion 15 starts the incoming call notifying control portion 16 to activate an incoming call notice such as an incoming ring sound, an incoming vibration or an incoming scrolling display. The processing are ended in a very short time.

When the incoming call notifying control portion 16 is started, it gives an incoming ring sound or an incoming vibration for a predetermined time and carries out an incoming scrolling display till an end part of display information. Accordingly, a time of several seconds or ten seconds, for example, is required for the processing.

In the case in which an incoming mail or an incoming phone call occurred dispersively at a long interval, the incoming call scrolling display has already been completed. In that case, the incoming call receiving portion 15 starts the incoming call notifying control portion 16 so that both of them are operated synchronously.

On the other hand, when a second incoming call is occurred asynchronously while the incoming call notifying control portion 16 is started to continuously carry out the incoming call scrolling display, the incoming call receiving portion 15 does not restart the incoming call notifying control portion 16 and the incoming call notifying control portion 16 decides a flag through an internal processing and carries out a processing which corresponds to the second incoming call.

Description will be given to various flags to be exchanged between the incoming call receiving portion 15 and the incoming call notifying control portion 16.

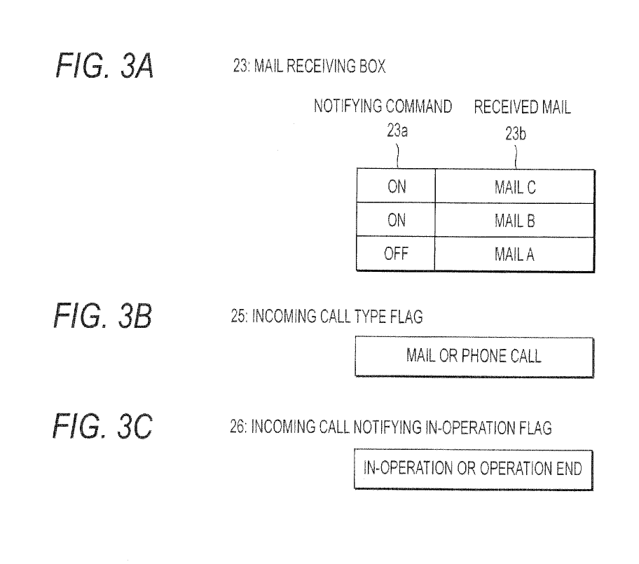

FIG. 3A to 3B are exemplary diagrams for explaining various flags to be exchanged between the incoming call receiving portion 15 and the incoming call notifying control portion 16 in the mobile apparatus.

FIG. 3A indicates the mail receiving box 23 which includes a received mail 23b column for storing a normal received mail and a notifying command 23a column for giving an instruction for a notice of an incoming call every received mail. When the incoming mail is received, the incoming call receiving portion 15 stores received mail information in the received mail 23b column and the notifying command 23a column for the mail is turned “ON”. The incoming call notifying control portion 16 checks the notifying command 23a column, and scrolls the received mail information in the “ON” state and turns “OFF” the notifying command 23a column at an ending time.

The state shown in FIG. 3A implies that the incoming call scrolling display of a mail A is ended and mails B and. C are received continuously, and their incoming call scrolling displays are waited to be started or the incoming call scrolling display is being carried out.

FIG. 3B illustrates the incoming call type flag 25. When an incoming call is received, the incoming call receiving portion 15 decides whether the incoming call is a mail or a phone call and records a “mail” or a “phone call” in the incoming call type flag 25. The incoming call notifying control portion 16 checks the incoming call type flag 25 and gives a notice corresponding to the mail or the phone call.

FIG. 3C illustrates the incoming call notifying in-operation flag 26. The incoming call notifying control portion 16 sets the flag into “in-operation” immediately after starting and sets the flag into “operation end” at the end of the incoming call scrolling display. More specifically, it is indicated whether the incoming call notifying control portion 16 is being started or not. Even if the incoming call is occurred, the incoming call receiving portion 15 does not start the incoming call notifying control portion 16 when the incoming call notifying in-operation flag 26 is “in-operation”.

Next, description will be given to a processing operation in the receipt of the incoming call of the incoming call receiving portion 15.

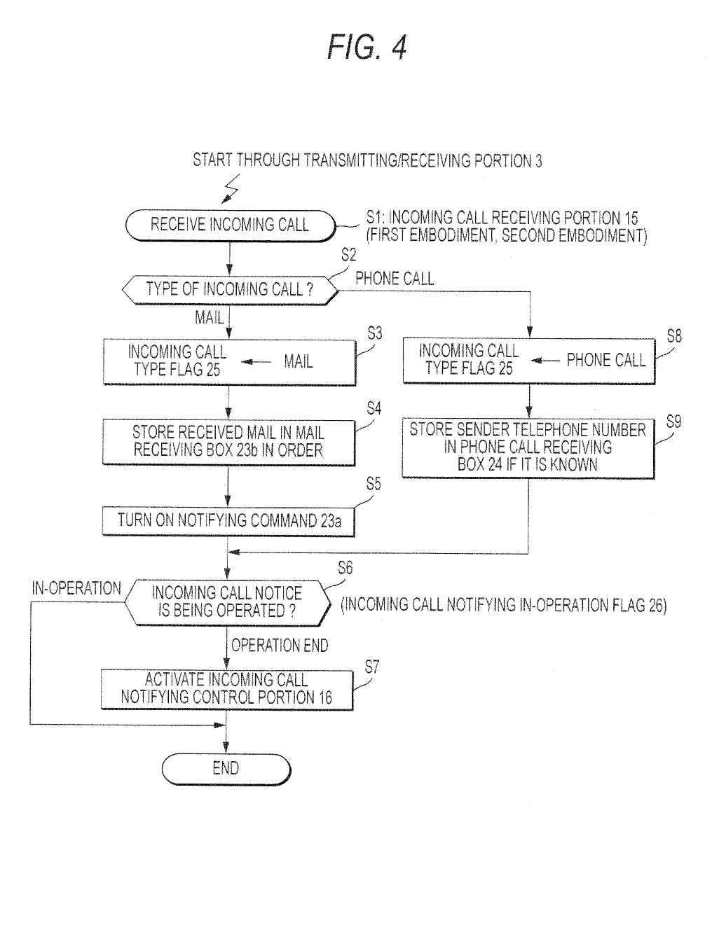

FIG. 4 is an exemplary operation flowchart for the incoming call receiving portion 15 of the mobile apparatus. The incoming call receiving portion 15 is activated in response to an incoming call signal sent from the transmitting/receiving portion 3 to start the incoming call receipt processing (Step S1) First of all, a type of an incoming call is decided in response to the incoming call signal transmitted from the transmitting/receiving portion 3 (Step S2). If the incoming call is that of a mail, the incoming call type flag 25 is set into “mail” (Step S3). Then, the received mails are stored in the mail receiving box 23b in order (Step S4). Thereafter, the notifying command 23a of the mail is turned “ON” (Step S5).

If the incoming call signal sent from the transmitting/receiving portion 3 represents the phone call at the Step S2, the incoming call type flag 25 is set into “phone call” (Step S8). If a sender telephone number of the incoming phone call is known, it is stored in the phone call receiving box 24 (Step S9).

Subsequently to the Steps S5 and S9, whether the incoming call notifying control portion 16 is being started is checked through the incoming call notifying in-operation flag 26 (Step S6). If “operation end” is set, the incoming call notifying control portion 16 is started (Step S7) and the processing is ended. If “in-operation” is set, the activation of the incoming call notifying control portion 16 (Step S7) is elapsed and the processing is ended.

### First Embodiment

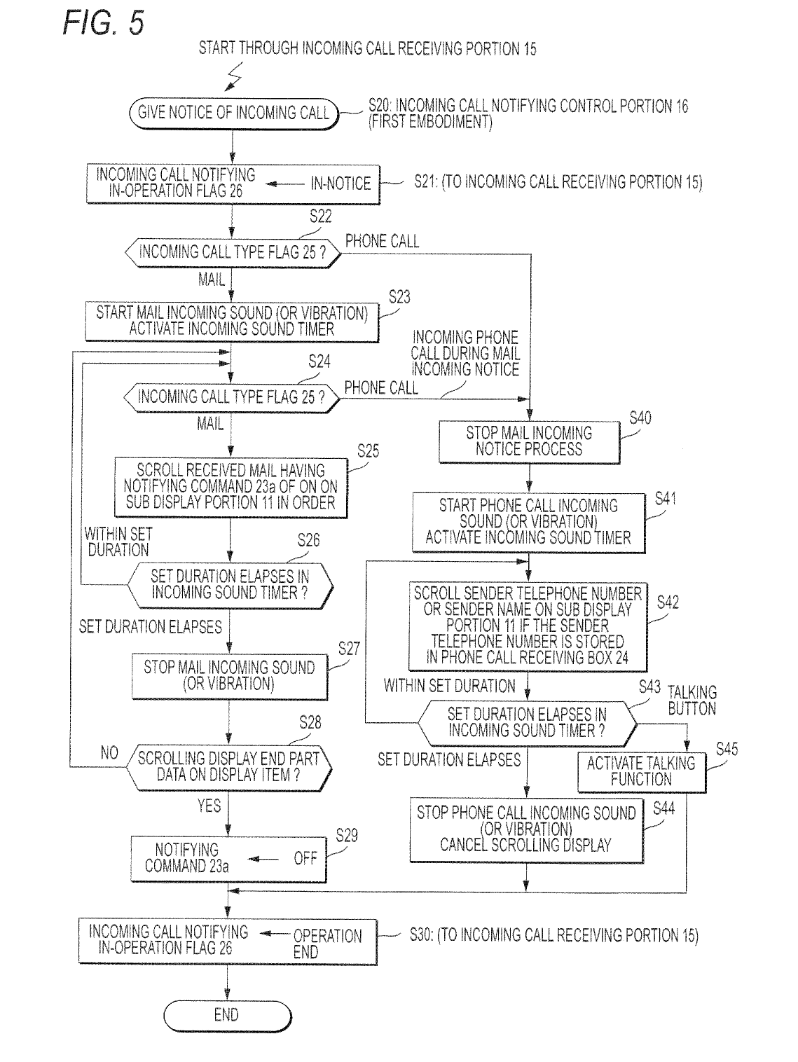

FIG. 5 is an exemplary operation flowchart for the incoming call notifying control portion 16 of the mobile apparatus 100 according to a first embodiment of the invention.

“The Case in which an Incoming Mail is Occurred”

An incoming mail is received and the incoming call notifying control portion 16 is started through the processing of the incoming call receiving portion 15 in FIG. 4 so that an incoming call notifying processing is operated (Step S20). The incoming call notifying control portion 16 first sets, into “in-operation”, the incoming call notifying in-operation flag 26 indicating that it is being activated (Step S21). Then, the incoming call type flag 25 is checked (Step S22). Because of “mail”, a mail incoming sound (or a vibration) is started and an incoming sound timer is activated (Step S23).

Next, the incoming call type flag 25 is checked in a loop (Step S24). This carries out a transition to a phone call incoming notice (after Step S40) when an incoming phone call is received during a continuous execution of a scrolling display processing in the loop.

When an incoming mail is occurred, “mail” is set at the Step S24 and a received mail also has “ON” in the notifying command 23a and is scrolled in the sub display portion 11 (Sep S25).

Next, the incoming sound timer checks whether a set duration elapses or not with the scrolling display operated continuously (Step S26). If the set duration does not elapse, the processing returns to the Step S24 and the loop is repeated. If the set duration elapses, the mail incoming sound (or vibration) is stopped (Step S27).

Then, it is checked whether or not the mail incoming sound is stopped arid the end part data are scrolled (Step S28). If the end part data are not scrolled perfectly, the processing returns to the Step S24 again and the loop is repeated. When the end part data are scrolled perfectly, the notifying command 23a is turned OFF (Step S29).

Thereafter, the incoming call notifying in-operation flag 26 is set into “operation end” in order to indicate that the processing of the incoming call notifying control portion 16 itself is ended (Step S30), and the processing of the incoming call notifying control portion 16 is ended.

“The Case in which a Next Incoming Mail is Continuously Received During the Scrolling Display of a Mail”

When a second incoming mail is then received, the incoming call receiving portion 15 in FIG. 4 turns “ON” the notifying command 23a of the received mail to bring a state in which the notifying commands 23a for a first mail B and a second mail C are turned ON as in the embodiment of FIG. 3A. Moreover, the incoming call receiving portion 15 does not restart the incoming call notifying control portion 16 because the incoming call notifying control portion 16 is being activated.

Accordingly, the incoming call notifying control portion 16 first recognizes that only the notifying command 23a for the mail B is ON, and scrolls the mail B at the Step S25 in the loop of the scrolling display. When the second mail C is received, however, the mails B and C are scrolled in order

“The Case in which an Incoming Phone Call is Received During the Scrolling Display of the Mail”

In case of the incoming phone call, the received contents cannot be dealt with later differently from the mail. Therefore, a notice of the incoming phone call is preferentially given. The incoming call receiving portion 15 in FIG. 4 sets the incoming call type flag into “phone call”. Moreover, the incoming call receiving portion 15 does not restart the incoming call notifying control portion 16 because the incoming call notifying control portion 16 is being activated.

Accordingly, the incoming call notifying control portion 16 recognizes “phone call” of the incoming call type flag at the Step S24 in the loop of the scrolling display and the processing proceeds to the incoming phone call notice (after Step S40). First of all, an incoming mail notice processing is stopped (Step S40). Then, a phone call incoming sound (or vibration) is started and the incoming sound timer is activated (Step S41).

If the phone call receiving box 24 has an sender telephone number, thereafter, a sender name of the address book 21 corresponding to the telephone number is scrolled in the sub display portion 11 (Step S42) and it is checked whether the set duration elapses in the incoming sound timer (Step S43). After the set duration elapses, the phone call incoming sound (or vibration) is stopped and the scrolling display is canceled (Step S44).

In order to indicate that the processing of the incoming call notifying control portion 16 itself is ended, the incoming call notifying in-operation flag 26 is set into “operation end” (Step S30) and the processing of the incoming call notifying control portion 16 is ended.

When the user pushes a talking button for the set duration of the incoming sound timer at the Step S43, a talking function (not shown) is started (Step S45) and the Step S30 is operated, and the processing of the incoming call notifying control portion 16 is ended.

“The Case in which an Incoming Phone Call is Occurred”

In that case, the incoming call type flag 25 in the Step S22 is recognized as “phone call” and the processing proceeds to the incoming phone call notice (after the Step S40).

Mail information to be scrolled at the Step S25 includes at least one of a mail address, a sender name (retrieved from the address book 21), a subject and a text, and the user may preset any of the information which is to be displayed.

While the end part data of the mail information are scrolled, moreover, this maybe repeated at least once to further decrease an oversight of the user.

In the case in which a plurality of mail subjects is displayed, furthermore, it is also possible to scroll a sender name and the number of subjects, for example, two subjects for Mr. A or one subject for Mr. A and one subject for Mr. B in place of the continuous scrolling display of each mail information.

In the case in which a plurality of mail subjects is displayed, moreover, it is also possible to scroll each mail information with a color varied.

According to the first embodiment, also after the incoming call notifying duration which is preset by the user elapses so that the incoming call notice is ended, the scrolling display in the sub display portion is continuously carried out till the end part data of the mail information. Therefore, the user can lessen an omission of a check at the sub display portion for the received mail information without opening the casings of the mobile apparatus 100 and executing other switching operations.

### Second Embodiment

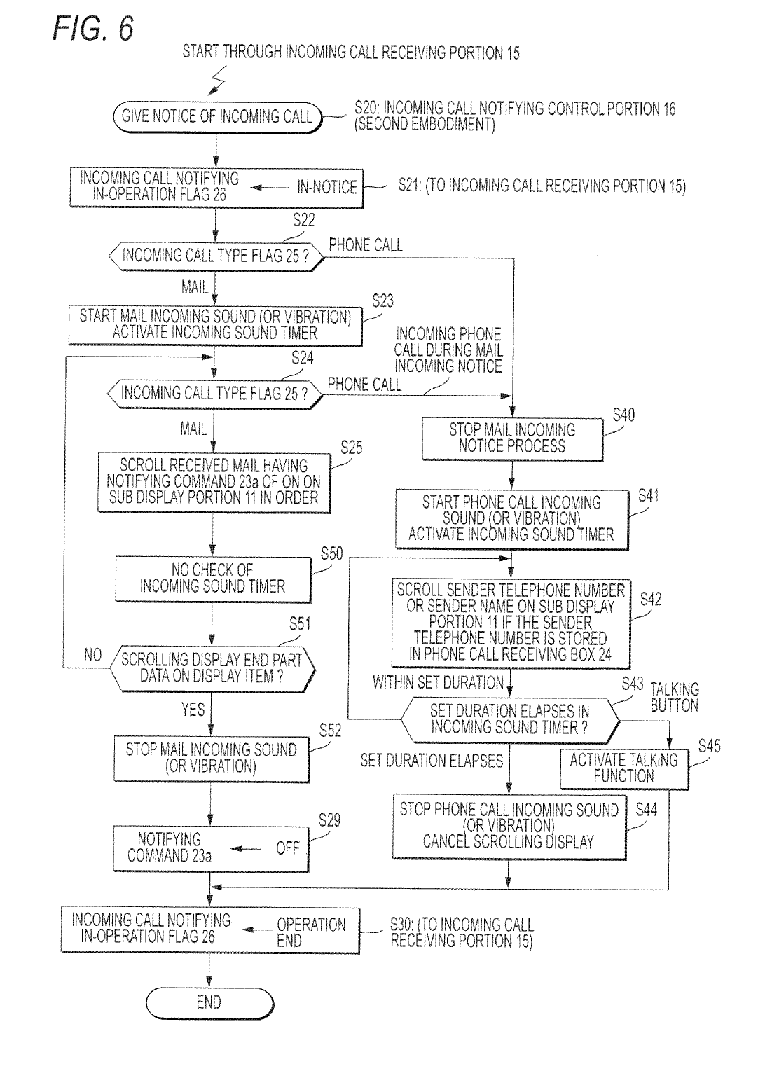

FIG. 6 is an exemplary operation flowchart for an incoming call notifying control portion 16 of a mobile apparatus 100 according to a second embodiment of the invention. A difference from the first embodiment will be mainly described. While the incoming call notice is stopped when the incoming call notifying duration set by the user is ended in the first embodiment (FIG. 5), the incoming call notice is not stopped even if the incoming call notifying duration set by the user is ended but the incoming call notice is prolonged until a scrolling display is ended in the second embodiment.

A different portion in the operation flowchart includes Steps S50, S51 and S52 in a loop portion for the scrolling display. At Step S23, a mail incoming sound (or vibration) is started and an incoming sound timer is activated. At the Step S50, however, the incoming sound timer does not carry out a check. More specifically, even if a set duration elapses in the incoming sound timer, the mail incoming sound is not stopped at that point.

When the end part data on a display item are scrolled perfectly (Step S51), the mail incoming sound (or vibration) is stopped (Step S52).

In the operation flowchart, the incoming sound timer is started at the Step S23 and the incoming sound timer does not carry out the check at the Step S50 in order to explain an incoming call sound. However, neither of the portions are required in the operation.

According to the second embodiment, even if the incoming call notifying duration which is preset by the user elapses, the incoming call information is continuously given until the scrolling display of the end part data of the mail information in the sub display portion is ended. Therefore, the user can lessen an omission of a check at the sub display portion for the received mail information without opening the casings of the mobile apparatus 100 and executing other switching operations.

What is claimed is:

1. A mobile apparatus comprising:
a notification section configured to notify a user of an incoming mail by means of sound or vibration;
a display section configured to display mail information related to the incoming mail;
a setting section configured to set an operation time of the notification section and to store the operation time based on the user's operation; and
a control section configured to activate the notification section during the operation time and to control the display section to scroll the mail information if the incoming mail is received,
wherein, if the operation time elapses, the control section controls the display section to continue a scrolling unless an end part of the mail information is displayed.

2. A mobile apparatus comprising:
an notification section configured to notify a user an incoming mail by means of sound or vibration;
a display section configured to display mail information related to the incoming mail;
a setting section configured to set an operation time of the notification section and to store the operation time based on the user's operation; and
a control section configured to activate the notification section to output the notice during the operation time and to control the display section to scroll the mail information if the incoming mail is received,
wherein, when the operation time elapses, the control section controls the display section to continue a scrolling and controls the notification section to continue notifying the user until an end part of the mail information is displayed.

3. The apparatus according to claim 1, wherein, if a second mail is received during the scrolling of the mail information, the control section controls the display section to continuously scroll the second mail information after the scrolling of the mail information until an end part of the second mail information is displayed.

4. The apparatus according to claim 1, wherein, if an incoming phone call is occurred during the scrolling of the mail information, the control section controls the display section to stop the scrolling, controls the notification section to notify the user of the incoming phone call by means of sound or vibration, and controls the display section to display a notice related to the incoming phone call.

5. The apparatus according to claim 1, wherein the control section controls the display section to repeatedly scroll the mail information.

6. The apparatus according to claim 1, wherein the mail information is set to include at least one of a mail address of a sender, a name of the sender, a subject of the mail, and a text of the mail based on the user's operation.

7. The apparatus according to claim 2, wherein, if a second mail is received during the scrolling of the mail information, the control section controls the display section to continuously scroll the second mail information after the scrolling of the mail information until an end part of the second mail information is displayed.

8. The apparatus according to claim 2, wherein, if an incoming phone call is occurred during the scrolling of the mail information, the control section controls the display section to stop the scrolling, controls the notification section to notify the user of the incoming phone call by means of sound or vibration, and controls the display section to display a notice related to the incoming phone call.

9. The apparatus according to claim 2, wherein the control section controls the display section to repeatedly scroll the mail information.

10. The apparatus according to claim 2, wherein the mail information is set to include at least one of a mail address of a sender, a name of the sender, a subject of the mail, and a text of the mail based on the user's operation.
